(19) United States
(12) Patent Application Publication
(10) Pub. No.: US 2009/0106969 A1
(43) Pub. Date: Apr. 30, 2009

(54) System and method for pre-featuring generic hard disk drive ready for customization

(76) Inventors: Kor Seng Ang, Singapore (SG); Hongyan Jiang, Singapore (SG); Richard C. Dyer, JR., Scotts Valley, CA (US); Shaoyong Liu, Singapore (SG)

Correspondence Address: HITACHI C/O WAGNER BLECHER LLP, 123 WESTRIDGE DRIVE, WATSONVILLE, CA, 95076, US

(21) Appl. No.: 11/981,870

(22) Filed: Oct. 31, 2007

(51) Int. Cl. G11B 5/127

(52) U.S. Cl. 29/603.03; 29/603.07; 29/603.09

(57) ABSTRACT

In accordance with certain aspects of the present invention, there is provided system and method for reducing the production cycle in the manufacturing of hard disk drives and a generic hard disk drive ready for customization. In one embodiment of the present invention a generic hard disk drive is provided. The generic disk drive includes a hard disk drive assembly and a printed circuit board having an electronic system for controlling the hard disk drive assembly with associated custom microcode specified by a customer during the customization of the generic disk drive.

### TECHNICAL FIELD

The present invention relates generally to a method and a system for manufacturing and fabricating hard drives in a manufacturing environment, and more particularly, to reducing the production cycle time of a hard disk drive and a generic hard disk drive ready for customization.

### BACKGROUND ART

Manufacturing assembly lines typically use in built-to-stock production models where large quantities of identical products are manufactured in anticipation of forecasted demands. The manufactured products are then warehoused until that demand is realized. Built-to-stock manufacturing systems are therefore primarily built to markets in which manufacturers can accurately predict customer demand.

However, predicting customer demand can be risky. For example, in the market for computer systems, technological improvements are realized so frequently used component prices change so rapidly that it is difficult to accurately predict how large the market for any particular product will ultimately be. As a result, when manufacturers in industries like information technology utilize the build-to-stock model, these manufacturers frequently find themselves with stock s of products that are difficult or impossible to market at a profit.

Another manufacturing model currently adopted by many companies is the just-in-time manufacturing model. This model entails the total elimination of waste in the manufacturing process requiring equipment, resource and labor to be made available only in the amount required and at the time required to do a job. It is based on producing only the necessary units in the necessary quantities at the necessary time by bringing production rates exactly in line with market demand. The problem with this type of manufacturing approach is that it leaves suppliers and downstream consumers open to supply shocks and large supply or demand changes

During hard disk drive manufacturing, the main components include a spindle assembly in which a number of disks are stacked at even intervals and fixed to an in-hub type spindle, an integrated actuator assembly in which there are a number of magnetic heads and an equal number of voice coil motors, a frame, an upper frame cover, bushings which secure the spindle assembly to the frame, and covers for holes opened in the sides of the frame.

Today customers are requesting shorter production cycle times starting from a hard disk drive order placement to order completion for delivery. However, each manufacturing step for a HDD takes a certain cycle time. In general, HDD manufacturing requires eight steps: 1) parts cleaning; 2) assembly at the clean room; 3) servo track writing on the disk; 4) leak testing; 5) card assembly; 6) function test; 7) stress test and 8) packaging. The cycle time assumes availability of a set of components and capacity to support the above process steps. The component and capacity are planned according to monthly demand forecasts. However, mismatch between the monthly demand forecast and customer orders as three months of more additional cycle time for long lead-time components and to setup capacity.

In addition, manufacturing may have completed HDD inventory that has functions that satisfies another customer. However, the manufacturer cannot ship the HDD because the HDD was assembled using a different specification, e.g., microcode or label. The personalization of the HDD occurs due to differing order activity. Thus, such a HDD becomes idle inventory unless reworked to meet a different specification. This can be time consuming and costly.

It can be seen then that there is a need for a method and system for reducing production cycle time of a hard disk drive and a generic hard disk drive ready for customization.

Therefore, what is need is a flexible way of component fabrication and manufacturing that permits the generic manufacturing of hard components of the HDD and the custom manufacturing of the soft components of the HDD at the end of the manufacturing process specifically based on customized customer specification.

### SUMMARY

In accordance with certain aspects of the present invention, there is provided system and method for reducing the production cycle in the manufacturing of hard disk drives and a generic hard disk drive ready for customization.

In one embodiment of the present invention a generic hard disk drive is provided. The generic disk drive includes a hard disk drive assembly and a printed circuit board having an electronic system for controlling the hard disk drive assembly with associated custom microcode specified by a customer during the customization of the generic disk drive.

In one embodiment, the present invention the generic printed circuit board enables the generic hard disk drive to undergo performance tests common to most of the customers who will use the hard disk drive in order to reduce the testing performed during the customization stage. The tested generic hard drive is then graded and stocked for custom featuring upon receipt of custom requests from customers thereby reducing the overall production cycle of the HDD.

### BRIEF DESCRIPTION OF THE DRAWINGS

The accompanying drawings, which are incorporated in and constitute a part of the specification, illustrate embodiments of the invention, and together with the general description given above and the detailed description given below serve to explain the teachings of the invention.

FIG. 1 is block diagram illustration of a conventional method for producing a hard disk drive.

FIG. 2 is a block diagram illustration of one embodiment of a HDD producing method in accordance with the present invention.

FIG. 3 is a block diagram illustration of one embodiment of a HDD in accordance to the present invention.

FIG. 4 is a process flow diagram of one embodiment of the production reduction cycle for the manufacturing of a generic hard disk drive of the present invention.

FIG. 5 is a block diagram illustration of pre-burn-in test manufacturing of a HDD in accordance to the present invention.

FIG. 6 is a block diagram illustration of a test analysis process of one embodiment of the present invention.

FIG. 7 is a block diagram illustration of one embodiment of a pre-configuration process of one embodiment of the present invention.

FIG. 8 is a block diagram illustration of a process flow of the pre-configuration process of one embodiment of the present invention.

### BEST MODES FOR CARRYING OUT THE INVENTION

Reference will now be made in detail to the alternative embodiment(s) of the present invention. While the invention will be described in conjunction with the alternative embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

The discussion will begin with an overview of a hard disk drive and components connected therewith. The discussion will then focus on embodiments of a method and system for limiting electrostatic discharge or electromagnetic interference during the manufacturing of the hard disk drive in a disk drive assembly environment by providing a flexible tubular wrist-strap cord holder for enabling an operator to remaining in a resonance frequency range consistent with that of components handled during the manufacturing of the hard disk drive.

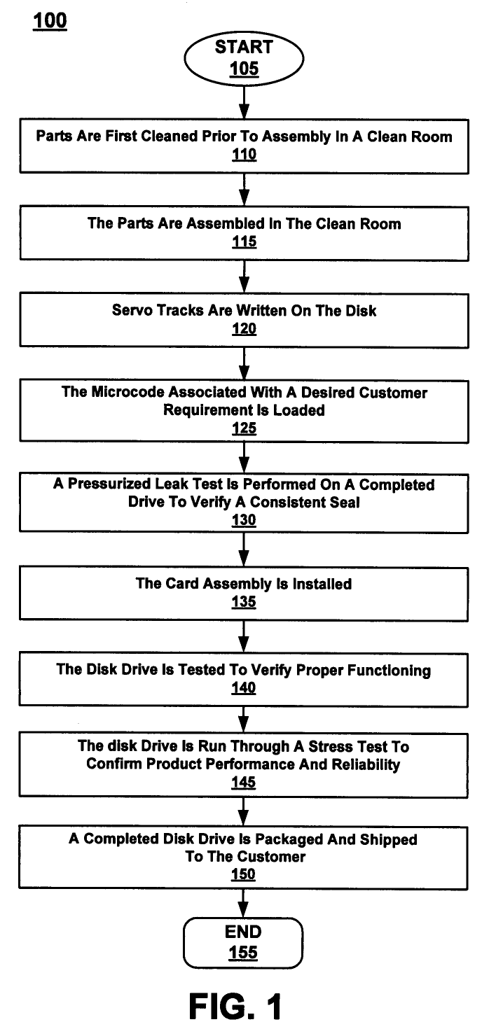

With reference now to FIG. 1 a typical method 100 for producing a hard disk drive is illustrated. In FIG. 1, parts are first cleaned prior to assembly in a clean room 110. Next, the parts are assembled in the clean room 120. Then, servo tracks on the disk 130. Microcode associated with a desired customer requirement is loaded 140. Manufacturers all maintain thousands of lines of proprietary code for each family of drives. For example, one family of drives may be configured with one of several different versions of microcode to satisfy the various requirements of OEMs. Thus, microcode is used to fine-tune the drive characteristics.

Thereafter, a pressurized leak test is performed on a completed drive to verify a consistent seal 150. At the whole drive level the design engineer must be concerned with drive sealing and particle generation. While the drive is spinning, internal air increases in temperature and pressure. When the disk stops spinning, the drive will take in dirty air if it is not completely sealed. Gaskets are designed to provide an airtight seal and slow the penetration of humidity. The base-plate and cover surface that interface with the gasket must be controlled to provide a flat wide surface against which to seal.

After performing the leak test, the card assembly is installed 160. The disk drive is then tested to verify proper functioning 170. Next, the disk drive is run through a stress test to confirm product performance and reliability 180. Finally, a completed disk drive is packaged and shipped to a customer 190.

Despite the seemingly unflawed flow of the process described above, mismatch between monthly demand forecasts and customer orders add three months of more additional cycle time for long lead time components and to setup capacity. Additionally, manufacturing may have completed HDD inventory that has functions that satisfies another customer. However, the manufacturer cannot ship the HDD because the HDD was assembled using a different specification, e.g., microcode or label. The personalization of the HDD occurs at the assembly at the clean room. This mismatch situation occurs due to differing order activity. Thus, such a HDD becomes idle inventory unless reworked to meet a different specification.

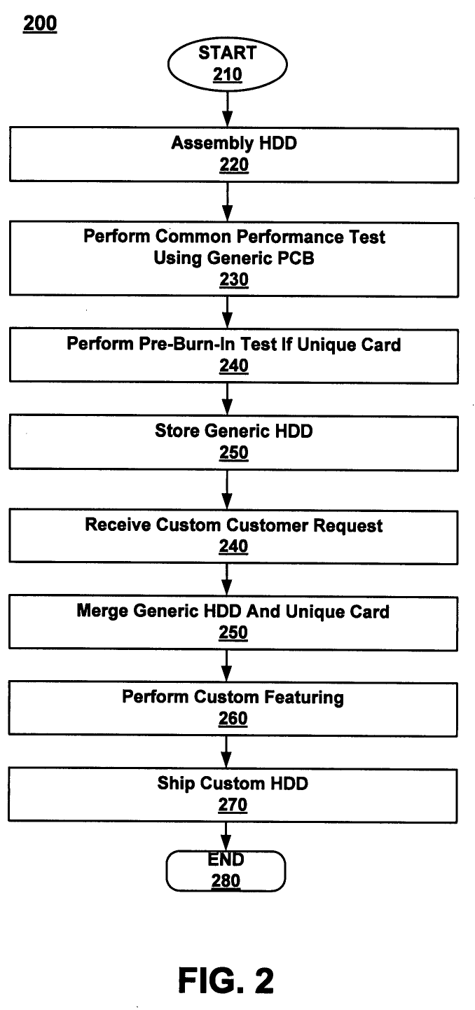

FIG. 2 is a block diagram illustrating a method 200 for reducing HDD production cycle time according to an embodiment of the present invention. The method illustrated in FIG. 2 includes a process of pre-featuring a generic hard disk drive ready for customization by testing an assembled HDD with a generic printed circuit board during the card assembly process of the HDD manufacturing process. There are several HDD performance testing in a customer featuring test which are common for most customer requirements. These common tests include Soft Error Rate testing, data transfer rate testing.

The present invention provides a method of performing all the common performance tests common to most HDDs without any customization using a generic printed circuit board (PCB) during the early stages of the manufacturing process. This enables a generic HDD to be manufactured and stocked for customized customer featuring thereby reducing the overall cycle time of manufacturing a customized HDD. In one embodiment, the generic PCB allows the generic HDD to undergo performance tests common to all the HDDs manufactured and later featured with customized soft unique features such as the addition of customer microcode, label, bracket, color, etc., based on a particular customer request.

As shown in FIG. 2, the HDD is assembled at step 220. Then all process for test completion is performed 230 using a generic PCB card assembly. In one embodiment, the test performed includes all tests that are common to the underlying hardware of the assembled HDD excluding any customer specific soft feature requests which can be accommodated at the end of the manufacturing process. This test may include a soft error rate testing, data transfer rate testing, etc.

Next, a pre-burn-in test of a unique card assembly is performed using generic featuring parameters from a pre-configuration server storing uploadable customization information. The tested HDD is then stored 250 as generic inventory.

When the customer request is received 260, the generic HDD is then merged 270 with the pre-burn-in unique card. Next, the merged HDD is then featured 280 with the specific customer specification and shipped 290 to the customer.

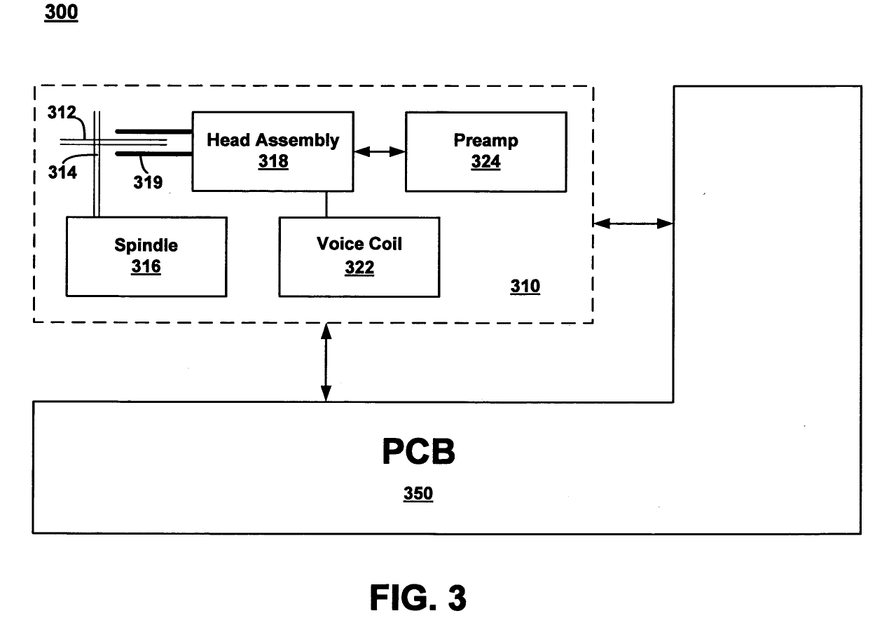

FIG. 3 is a block diagram of one embodiment of the generic HDD 300 in accordance with the teaching of the present invention. The generic HDD 300 includes a head and disk assembly (HDA) 310 and associated card assembly including the generic printed circuit board 350 of the present invention. In the HDA 310, magnetic disks 312 for storing information are mounted on a single spindle 314. The spindle 314 is rotated by a spindle motor 316.

A head assembly 318 controls movement of the heads 319 relative to the magnetic disks 312. A voice coil motor 322 controls motions of the heads 319 via the head assembly 318. The head disk assembly 310 may also include a preamplifier 324 for writing and reading of information to the magnetic disks 312.

The PCB 350 includes the electronics required for the operation of the HDD. In one embodiment of the present invention, the PCB 350 includes micro-controllers and microcode ROM which may be customized based on specific customer specification to meet the needs of the customer. By using the generic PCB 350, a generic HDD is assembled, tested and inventoried for further customization with soft featuring customer requests.

In one embodiment, through the testing process, specific information about the HDD such as the proper functioning of the recording channel, servo control, defect management and cache management are recorded into flash memory and the magnetic medium (disks). Thus, any physical separation of the PCB 350 from the HDE will practically destroy the identity of the HDD 300.

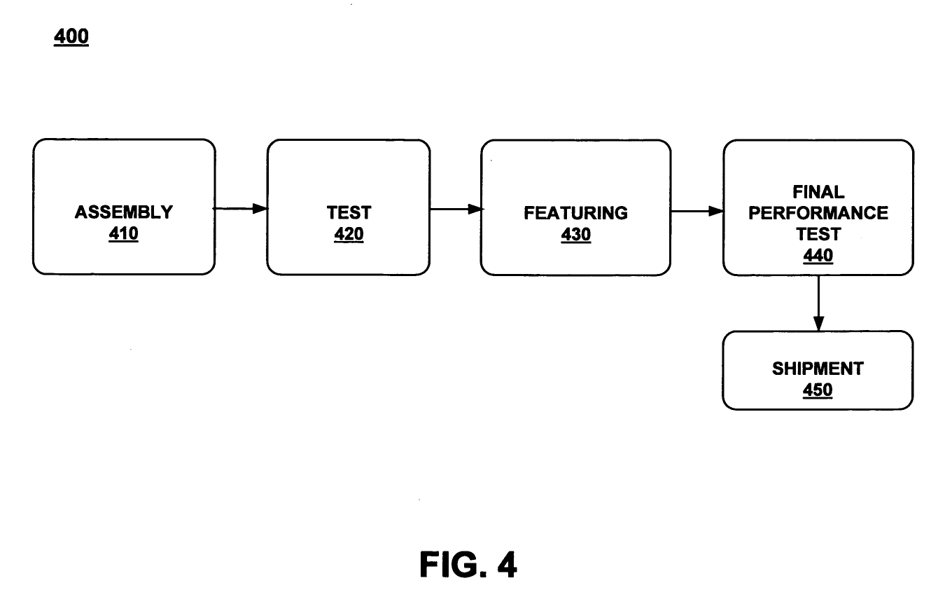

FIG. 4 illustrates a production line flow 400 illustrating the method for reducing the production cycle for manufacturing a generic hard disk drive according to one embodiment of the present invention. As illustrated in FIG. 4, the production cycle of the present invention includes an assembly stage 410, a test performance stage 420, a custom featuring stage 430, a final test performance stage 440 and a shipping stage 450.

The test performance stage 420 includes completion of all the functional testing of the generic hard disk drive. In one embodiment, the testing stage 420 also includes a pre-burn-in test of the printed circuit board in full functional condition. All test conducted in the testing stage 420 are common to all the generic hard disk drive manufactured in the assembly line 400 regardless of the final customer specification.

All custom customer specifications are performed during the featuring stage 430 where a generic hard disk drive is featured with specific soft customer specification such as labeling, microcode loading, etc. After custom featuring, a final test is performed to ensure that the featured drive works as specified by the customer. If the featured drive passes final test, it is shipped to the customer.

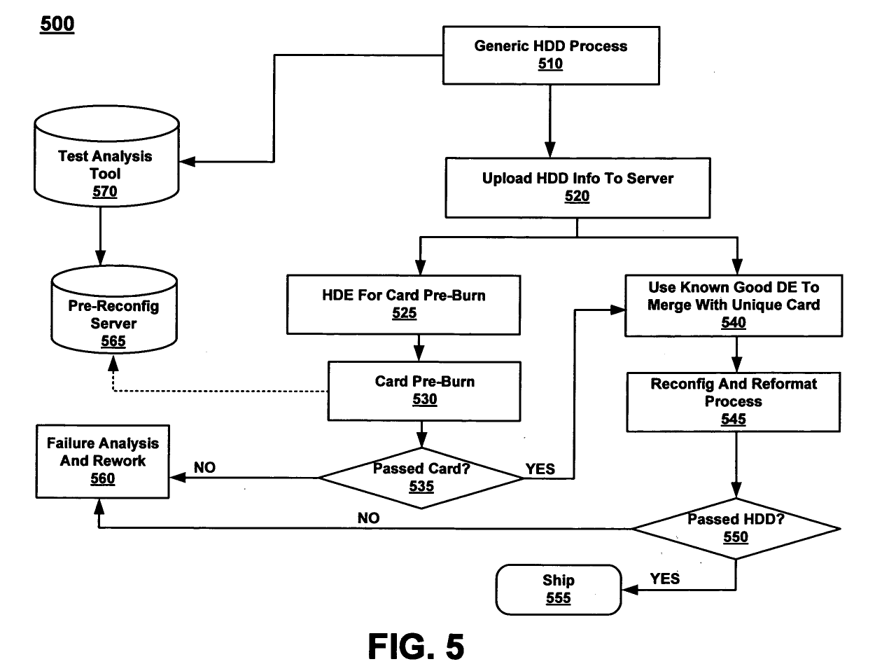

FIG. 5 illustrates one embodiment of a Pre-Burn-in process of generic HDD in accordance to embodiments of the present invention. In the example illustrated in FIG. 5, the printed circuit board (PCB) undergoes a pre-burn-in test in full functional condition. As shown in FIG. 5, after assembly of the generic HDD, the HDD that passes the initial processing tests, the testing data is uploaded 510 for each HDD that passes to a pre-configuration server. Concurrently, the testing data is also provided to a test analysis tool process 520.

The data uploaded to the pre-configuration server is used for the preparation 520 of unique PCBs with generic featuring parameters retrieved from the pre-configuration server. Next, a determination 530 is made to see if the unique card passes the burn-in test. If the unique card passes the burn-in test then upon receipt of a customer request, the unique card is merged 540 with a known good inventoried generic HDD.

The merged HDD is then subjected to a final performance test and if the merged HDD passes 550, the merged HDD is loaded with the specific customer request with the loading of control firmware from the pre-configuration server to the merged HDD's flash memory. Servo and read/write channel data is also retrieved from the pre-configuration server and written to the merged HDD. A final performance test is performed and if the merged HDD passes the performance test, it is shipped to the customer. However, if the merged HDD fails the final performance test, the HDD is sent for a fail analysis or rework.

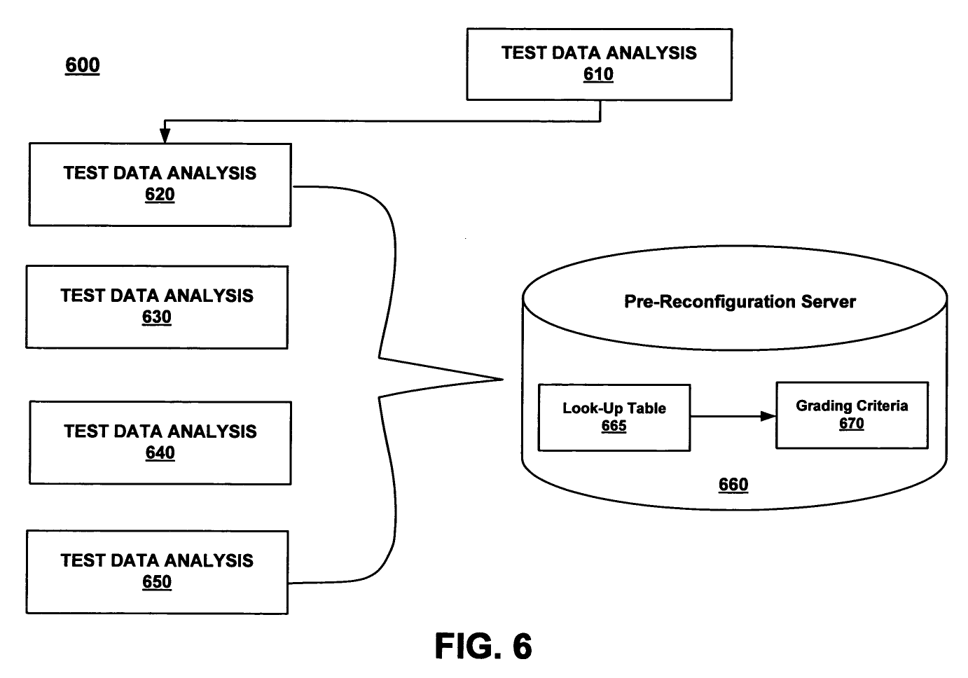

FIG. 6 is an illustration of one embodiment of the test analysis method in accordance to embodiments of the present invention. As shown in FIG. 6, the test data analysis 610 commences with the generic test result from the testing of the generic HDD with the accompanying generic PCB being filtered into data channel 620, defect information 630, servo mechanics information 640 and performance management information 650.

The filtered information is then stored in the pre-reconfiguration server 660. In the pre-reconfiguration server 660, the stored information is matched against application requirement data in lookup table 665. The result from the data lookup is grade according to a grading criteria 670 to ensure consistency with the test parameters during the testing process.

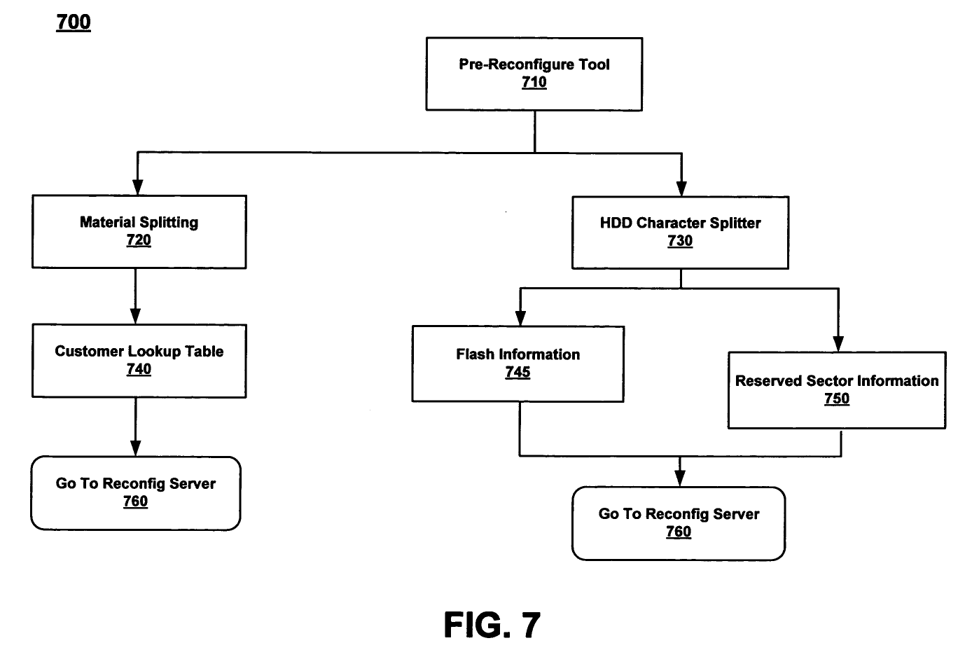

Reference is now made to FIG. 7 which illustrates one embodiment of the pre-configuration process in accordance to embodiments of the present invention. As shown in FIG. 7, the pre-configuration process 700 first strips the manufacturing relationship between HDD materials 720 and HDD characteristics 730 to separate the common material components of the HDD from the unique HDD information respectively for each HDD being tested.

The information from the material splitting process 720 is matched against pre-stored customer information in the customer lookup table 740 and the matched information is then loaded into the reconfiguration server. The HDD character splitting process 730 is stored in flash memory 745 and reserve sector information unit 750. Both information from the flash memory 745 and the reserve sector unit 750 are the loaded into the reconfiguration server to be used during the customization process of the tested generic HDD.

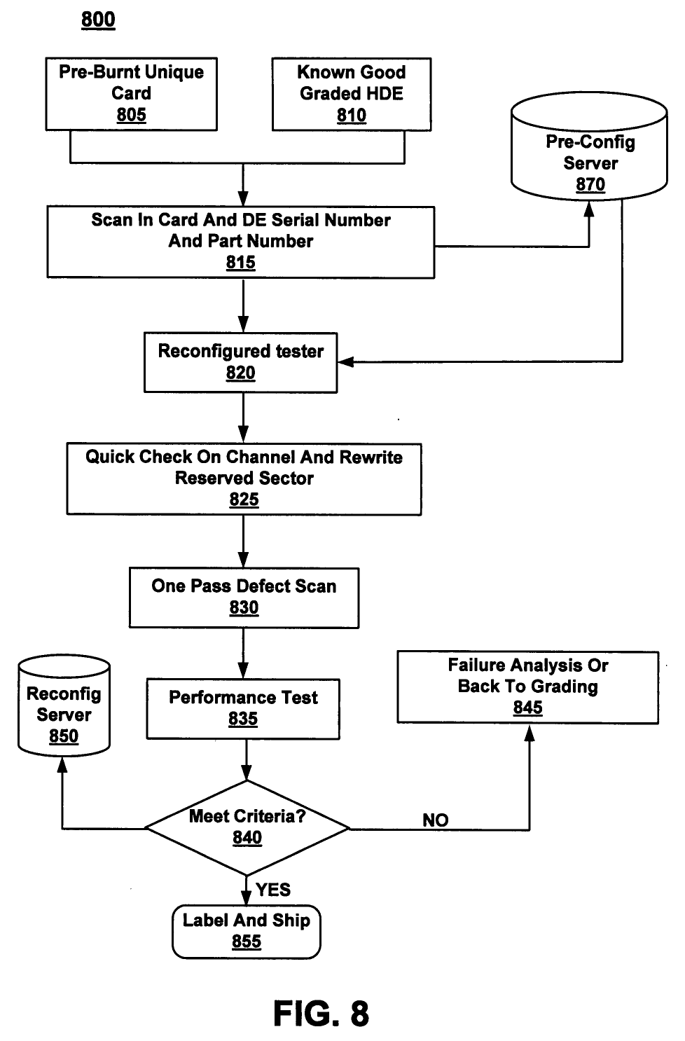

FIG. 8 illustrates one embodiment of the merging of the generic drive of one embodiment of the present invention with a unique pre-burn-in printed circuit board upon receipt of a custom request from a customer. As shown in FIG. 8, upon receipt of the custom request from a customer, the pre-burn-in unique printed circuit board 805 is merged with a graded inventoried generic hard disk drive 810.

The merged hard disk drive is then scanned 815 with the part numbers of the various constituent components and the serial number of the drive. The scanned information is then presented 820 to a reconfiguration tester.

The tester performs a quick check 825 of the data channel of the merged drive and a rewrite of the reserved sectors of the merged drive is performed. After that, a one pass scan 830 is performed to scan the merged drive for defects.

A final performance test 835 is then performed. If the merged drive meets the requested specified customer criteria 840, the drive information is sent to the reconfiguration server 850. However, if after the final performance test 845, the merged drive fails the criteria test 840, the drive is sent for failure analysis or back to be regarded 845.

If after the final performance test the merged drive meets the specified customer criteria, the drive is shipped 855 to the customer

Example embodiments of the present technology are thus described. Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of manufacturing a generic hard disk drive that is customized responsive to a specific customer specification, the method comprising:
pre-featuring a generic hard disk drive with generic components including a generic printed circuit board;
performing a fully functional test of the generically manufactured hard disk drive using the generic printed circuit board; and
featuring the generically manufactured hard disk drive with custom customer specification in response to a specific customer request.

2. The method of claim 1, wherein the performing of the fully functional test comprises generating performance test data for each generically assembled hard disk drive, said performance test data being stored in a pre-featuring configuration server to preserve the identity of each generic hard disk drive manufactured.

3. The method of claim 2, wherein upon receipt of the specific customer request the performance data stored in the pre-featuring configuration server is compared with look-up data stored in look-up tables in the configuration server to identify a matching generic hard disk drive to the requested customer request.

4. The method of claim 3, wherein the performance data includes data channel information for identifying a particular generically assembled hard disk drive.

5. The method of claim 3, wherein the performance data further includes defect management data for the particular generically assembled hard disk drive.

6. The method of claim 5, wherein the performance data further includes servo mechanics data for the particular generically assembled hard disk drive.

7. The method of claim 6, wherein the generically assembled hard disk drive pass the performance test are graded according a set of performance results corresponding to anticipated custom customer requests.

8. The method of claim 7, wherein performing a pre-featuring test of the generically assembled hard disk drive reduces the cycle time to customized the generic hard disk drive when the custom customer request is received.

9. A method for manufacturing generic hard disk drives that are ready for custom featuring according to specific custom customer requests, comprising:
assembling the hard disk drives;
testing the assembled hard disk drives with generic printed circuit boards to reduce the assembly cycle of the generic hard disk drives during the custom featuring of the hard disk drives;
grading the generic hard disk drives that pass the testing;
storing the graded hard disk drives to await customer order requests; and
featuring the stored generic hard disk drives with requested custom customer specification.

10. The method of claim 9, further comprising performing a final performance test prior to shipping the featured generic hard disk drives to the customer.

11. The method of claim 10, wherein the generic printed circuit board is pre-burn-in in full functional condition.

12. The method of claim 11 further comprising preserving and transferring the identity of the generic hard disk drives after the performance test in a configuration server for storage until a custom customer request is received to custom feature the generic drives.

13. The method of claim 12, wherein the performance test utilizes a test analysis tool to control inventory of the tested drives.

14. The method of claim 13, wherein the test analysis tool comprises filtering the generic performance test information performed with the generic printed circuit board into a data channel data.

15. The method of claim 14, wherein the test analysis tool further comprises filtering the generic performance test information into a defect distribution data.

16. The method of claim 15, wherein the test analysis tool further comprises filtering the generic performance test information into a servo management data.

17. The method of claim 16, wherein the servo mechanics data, the defect distribution data and the data channel data are stored in a look-up table for subsequent use during the custom featuring of the drives.

18. The method of claim 9 wherein the testing of the assembled hard disk drives includes conducting a soft error rate test.

19. The method of claim 18 further comprising conducting a data transfer rate test.
